(19) United States
(12) Patent Application Publication
(10) Pub. No.: US 2022/0414679 A1
(43) Pub. Date: Dec. 29, 2022

(54) Third Party Security Control Sustenance Model

(71) Applicant: Bank of America Corporation, Charlotte, NC (US)

(72) Inventors: Abhishek Kumar, Hyderabad (IN); Nikhil Banwarilal Bagaria, Mumbai (IN)

(21) Appl. No.: 17/362,027

(22) Filed: Jun. 29, 2021

(51) Int. Cl. G06Q 30/00; G06Q 30/02; G06Q 10/06; G06N 20/00

(52) U.S. Cl. CPC G06Q 30/018; G06Q 30/0203; G06Q 10/0635; G06N 20/00

(57) ABSTRACT

Aspects of the disclosure relate to training a machine learning model to continuously sustain security assessment protocols on vendor computing devices. In some embodiments, a machine learning engine may analyze vendor compliance data from previous security assessments, compliance requirements for security gaps that are commonly reported during security assessments, and enterprise security requirements. A security assessment platform may generate and transmit, to a vendor computing device, a plurality of security assessment surveys and instructions for completing a security assessment survey. The machine learning engine may analyze the responses provided on the completed security assessment survey. The security assessment platform may transmit either a notification of compliance or a notification of non-compliance to the enterprise organization. The security assessment platform may continuously perform security assessments, depending on the security risk level of the vendor, to ensure the vendor complies with the prescribed security requirements.

### BACKGROUND

Aspects of the disclosure relate to hardware and software for training a machine learning engine to continuously sustain security assessment protocols on vendor computing devices. In particular, one or more aspects of the disclosure relate to initializing a machine learning engine to generate security assessment surveys and assess the responses on the security assessment surveys, provided by a vendor computing device, to determine whether the vendor computing device complies with security requirements established by an enterprise organization.

Current security assessment protocols within an enterprise organization may prescribe a point-in-time security assessment that is performed once per year or once every two years. During each point-in-time security assessment, vendors who provide services to the enterprise organization may be identified. Each vendor's behavior may be analyzed using enterprise security requirements that are generated by the enterprise organization. The enterprise security requirements generated by the enterprise organization may be a series of security-related queries that are designed to assess whether a vendor's behavior complies with the overall security mission of the enterprise organization.

An enterprise organization may partner with a plurality of vendors. Each vendor that partners with the enterprise organization may gain access to sensitive information within the enterprise organization. As such, it becomes increasingly important to monitor vendor behavior to ensure each vendor complies with the security requirements generated by the enterprise organization. However, point-in-time security assessments are not sufficient for monitoring vendor behavior as point-in-time assessments do not provide a method for real-time security assessment.

### SUMMARY

Aspects of the disclosure provide effective, efficient, and convenient technical solutions that address and overcome the technical problems associated with ensuring vendor behavior complies with the enterprise security requirements established by the enterprise organization.

In accordance with one or more embodiments, a computing platform comprising at least one processor, a communication interface communicatively coupled to the at least one processor, and memory storing computer-readable instructions that, when executed by the at least one processor, may cause the computing platform to receive, via a connection established with an enterprise compliance administrator computing device, enterprise security requirements transmitted from the enterprise compliance administrator computing device. The computing platform may generate, based on machine learning analysis, a plurality of security assessment surveys. The computing platform may generate a plurality of answer templates corresponding to each security assessment survey of the plurality of the security assessment surveys. In some examples, the answer templates may include instructions, to be executed by a vendor computing device, for completing the security assessment survey. The computing platform may transmit, via a connection established with the vendor computing device, the plurality of the security assessment surveys and the plurality of the answer templates to the vendor computing device. The computing platform may receive, from the vendor computing device, a completed security assessment survey including security assessment response data. The computing platform may analyze, based on the machine learning analysis, the completed security assessment survey including the security assessment response data. The computing platform may generate a notification, the notification including one of either compliance with the enterprise security requirements based on determining that the security assessment response data provided on the completed security assessment survey satisfies the enterprise security requirements or noncompliance with the enterprise security requirements based on determining that the security assessment response data provided on the completed security assessment survey does not satisfy the enterprise security requirements. The computing platform may transmit, to the enterprise compliance administrator computing device, the generated notification.

In accordance with one or more embodiments, a method may comprise, at a computing platform comprising at least one processor, memory, and a communication interface, receiving, via a connection established with an enterprise compliance administrator computing device, enterprise security requirements transmitted from the enterprise compliance administrator computing device. The method may comprise generating, based on machine learning analysis, a plurality of security assessment surveys. The method may comprise generating a plurality of answer templates corresponding to each security assessment survey of the plurality of the security assessment surveys, and including instructions, to be executed by a vendor computing device, for completing the security assessment survey. The method may comprise transmitting, via a connection established with the vendor computing device, the plurality of the security assessment surveys and the plurality of the answer templates to the vendor computing device. The method may comprise receiving, from the vendor computing device, a completed security assessment survey including security assessment response data. The method may comprise analyzing, based on the machine learning analysis, the completed security assessment survey including the security assessment response data. The method may comprise generating a notification, the notification including one of either compliance with the enterprise security requirements based on determining that the security assessment response data provided on the completed security assessment survey satisfies the enterprise security requirements or noncompliance with the enterprise security requirements based on determining that the security assessment response data provided on the completed security assessment survey does not satisfy the enterprise security requirements. The method may comprise transmitting, to the enterprise compliance administrator computing device, the generated notification.

In accordance with one or more embodiments, one or more non-transitory computer-readable media may store instructions that, when executed by a computing platform comprising at least one processor, memory, and a communication interface, cause the computing platform to receive, via a connection established with an enterprise compliance administrator computing device, enterprise security requirements transmitted from the enterprise compliance administrator computing device. The instructions, when executed, may cause the computing platform to generate, based on machine learning analysis, a plurality of security assessment surveys. The instructions, when executed, may cause the computing platform to generate a plurality of answer templates corresponding to each security assessment survey of the plurality of the security assessment surveys, and including instructions, to be executed by a vendor computing device, for completing the security assessment survey. The instructions, when executed, may cause the computing platform to transmit, via a connection established with the vendor computing device, the plurality of the security assessment surveys and the plurality of the answer templates to the vendor computing device. The instructions, when executed, may cause the computing platform to receive, from the vendor computing device, a completed security assessment survey including security assessment response data. The instructions, when executed, may cause the computing platform to analyze, based on the machine learning analysis, the completed security assessment survey including the security assessment response data. The instructions, when executed, may cause the computing platform to generate a notification, the notification including one of either compliance with the enterprise security requirements based on determining that the security assessment response data provided on the completed security assessment survey satisfies the enterprise security requirements or noncompliance with the enterprise security requirements based on determining that the security assessment response data provided on the completed security assessment survey does not satisfy the enterprise security requirements. The instructions, when executed, may cause the computing platform to transmit, to the enterprise compliance administrator computing device, the generated notification.

The features described herein significantly improve the current method of using point-in-time assessments to perform security assessments on vendor computing devices. In particular, the features described herein may provide the following benefits: 1) assurance that the identified security gaps are remedied and sustained until the next security assessment; 2) identification of repeated security gaps; 3) real-time monitoring of vendor behavior; 4) an improved relationship between the vendor and the enterprise organization; 5) allow an enterprise organization to review a vendor's security assessment history prior to awarding additional contracts to that vendor; 6) allow an enterprise organization to strategize the roll out of new technology using each vendor's security assessment history; and/or 7) improved security of the enterprise organization.

These features, along with many others, are discussed in greater detail below.

### BRIEF DESCRIPTION OF THE DRAWINGS

The present disclosure is illustrated by way of example and is not limited in the accompanying figures in which like reference numerals indicate similar elements and in which:

FIG. 1A depicts an illustrative computing environment for training and using a machine learning engine to continuously sustain security assessment protocols on vendor computing devices in accordance with one or more example embodiments;

FIG. 1B depicts an illustrative security assessment platform for training and using a machine learning engine to continuously sustain security assessment protocols on vendor computing devices in accordance with one or more example embodiments;

FIGS. 2A-2H depict an illustrative event sequence for training and using a machine learning engine to continuously sustain security assessment protocols on vendor computing devices in accordance with one or more example embodiments;

FIG. 3 depicts an illustrative method for training and using a machine learning engine to continuously sustain security assessment protocols on vendor computing devices in accordance with one or more example embodiments; and

FIGS. 4-6 depict exemplary notifications transmitted to a user interface while training and using a machine learning engine to continuously sustain security assessment protocols on vendor computing devices in accordance with one or more example embodiments.

### DETAILED DESCRIPTION

In the following description of various illustrative embodiments, reference is made to the accompanying drawings, which form a part hereof, and in which are shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, conventional point-in-time security assessments might not provide a sufficient method of monitoring vendor behavior as point-in-time security assessments are performed once per year or once every two years. Accordingly, aspects described herein are directed to real-time monitoring of vendor computing devices. For instance, a machine learning engine may analyze vendor behavior in previous security assessments, compliance requirements for security gaps that are commonly reported during security assessments, and enterprise security requirements to determine the security requirements that may be evaluated during the next security assessment. Based on the analysis by the machine learning engine, a security assessment platform may generate a plurality of security assessment surveys containing the security requirements which may be used to evaluate vendor behavior.

The security assessment platform may distribute the plurality of security assessment surveys to one or more vendor computing devices and provide instructions to the one or more vendor computing devices for completing the security assessment survey. Upon receipt of the completed security assessment survey, including security assessment response data from the one or more vendor computing devices, the security assessment platform may analyze the response data based on further analysis by the machine learning engine. The security assessment platform may then transmit a notification of compliance or non-compliance to an enterprise organization computing device to inform the enterprise organization of whether the vendor satisfied the security requirements that were evaluated during the security assessment. The security assessment platform may transmit a notification of non-compliance to the one or more vendor computing devices along with guidelines that a vendor computing device may execute to comply with the security requirements. When a notification of non-compliance is transmitted, the security assessment platform may determine a time frame within which to perform a subsequent security assessment on the non-compliant vendor.

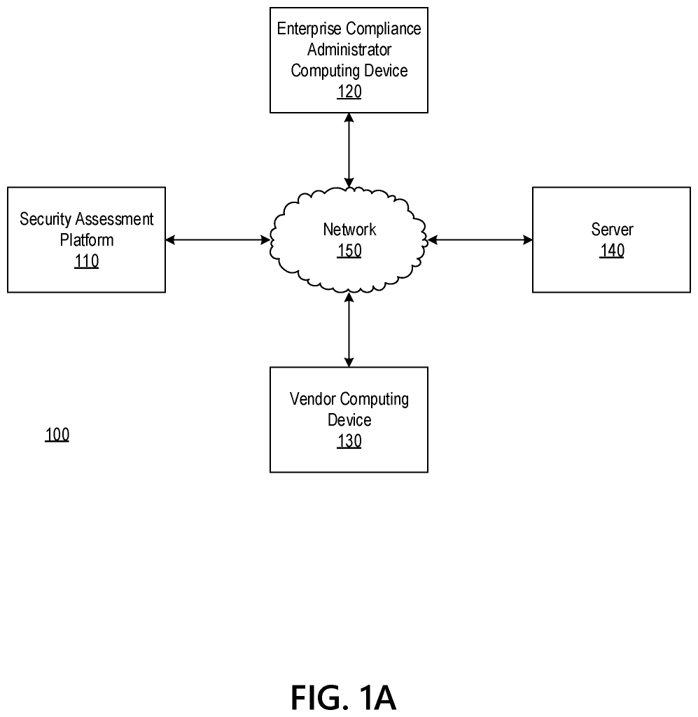

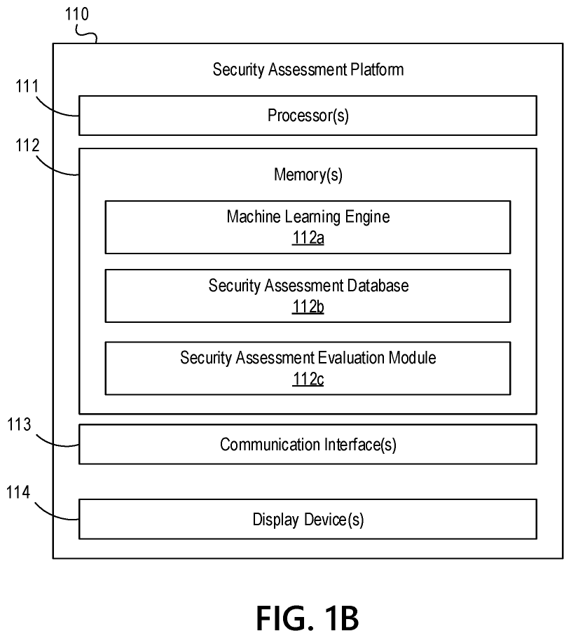

FIG. 1A depicts an illustrative computing environment for training a machine learning engine to continuously sustain security assessment protocols on vendor computing devices in accordance with one or more example embodiments. Referring to FIG. 1A, computing environment 100 may include one or more computer systems and networks. For example, computing environment 100 may include security assessment platform 110, enterprise compliance administrator computing device 120, vendor computing device 130, server 140, and network 150.

As discussed in greater detail below in connection with FIG. 1B, security assessment platform 110 may include one or more processor(s) 111, memory(s) 112, communication interface(s) 113, and display device(s) 114. Memory 112 may include machine learning engine 112a, security assessment database 112b, and security assessment evaluation module 112c. Memory 112 may be configured to perform one or more of the functions described herein.

Enterprise compliance administrator computing device 120 may include one or more computing devices and/or other computer components (e.g., processors, memories, communication interfaces, di splay devices). Enterprise compliance administrator computing device 120 may be a mobile computing device (e.g., smartphone, tablet, laptop computer, or the like). Enterprise compliance administrator computing device 120 may be linked to and/or used by a user (who may, e.g., be an employee or other individual authorized to access enterprise resources). Enterprise compliance administrator computing device 120 may include one or more processor(s), memory(s), communication interface(s), and display device(s). A data bus may interconnect the processor, the memory, the communication interface, and the display device. The communication interface may be a network interface configured to support communication between enterprise compliance administrator computing device 120 and network 150. The memory may include one or more program modules having instructions that, when executed by the processor, may cause enterprise compliance administrator computing device 120 to perform one or more functions described herein and/or one or more databases to store and/or otherwise maintain information which may be used by such program modules and/or the processor. In some instances, the one or more program modules and/or databases may be stored and/or maintained in different memory units of enterprise compliance administrator computing device 120.

Vendor computing device 130 may include one or more computing devices and/or other computer components (e.g., processors, memories, communication interfaces, display devices). Vendor computing device 130 may be a mobile computing device (e.g., smartphone, tablet, laptop computer, or the like). Vendor computing device 130 may be linked to and/or used by a user (who may, e.g., be an employee or other individual authorized to access vendor resources and enterprise resources). Vendor computing device 130 may include one or more processor(s), memory(s), communication interface(s), and display device(s). A data bus may interconnect the processor, the memory, the communication interface, and the display device. The communication interface may be a network interface configured to support communication between vendor computing device 130 and network 150. The memory may include one or more program modules having instructions that, when executed by the processor, may cause vendor computing device 130 to perform one or more functions described herein and/or one or more databases to store and/or otherwise maintain information which may be used by such program modules and/or the processor. In some instances, the one or more program modules and/or databases may be stored and/or maintained in different memory units of vendor computing device 130.

In some arrangements, enterprise compliance administrator computing device 120 may be owned and/or operated by an enterprise organization. In addition, vendor computing device 130 may be owned and/or operated by an entity different from the enterprise organization, such as vendors who supply a variety of services to the enterprise organization.

Computing environment 100 also may include one or more networks, which may interconnect one or more of security assessment platform 110, enterprise compliance administrator computing device 120, vendor computing device 130, and server 140. For example, computing environment 100 may include network 150 (which may, e.g., connect security assessment platform 110, enterprise compliance administrator computing device 120, vendor computing device 130, and server 140).

In one or more arrangements, security assessment platform 110, enterprise compliance administrator computing device 120, and vendor computing device 130 may be any type of computing devices capable of receiving a user interface, receiving input via the user interface, and communicating the received input to one or more other computing devices. For example, security assessment platform 110, enterprise compliance administrator computing device 120, and vendor computing device 130, and/or the other systems included in computing environment 100 may, in some instances, include one or more processors, memories, communication interfaces, display devices, storage devices, and/or other components. As noted above, and as illustrated in greater detail below, any and/or all of security assessment platform 110, enterprise compliance administrator computing device 120, and vendor computing device 130 may, in some instances, be special-purpose computing devices configured to perform specific functions.

Referring to FIG. 1B, security assessment platform 110 may include one or more processor(s) 111 and memory(s) 112. A data bus may interconnect processor 111 and memory 112. Memory 112 may include one or more program modules having instructions that, when executed by processor 111, may cause security assessment platform 110 to perform one or more functions described herein and/or may cause one or more databases to store and/or otherwise maintain information which may be used by such program modules and/or processor 111. In some instances, the one or more program modules and/or databases may be stored and/or maintained in different memory units of security assessment platform 110 and/or by different computing devices that may form and/or otherwise make up security assessment platform 110. For example, memory 112 may have, store, and/or include machine learning engine 112a, security assessment database 112b, and security assessment evaluation module 112c. Machine learning engine 112a may be trained to continuously sustain security assessment protocols on vendor computing devices, as discussed in greater detail below. Security assessment database 112b may store the security assessment data that is transmitted to and received by security assessment platform 110. Security assessment evaluation module 112c may be trained to continuously sustain security assessment protocols on vendor computing devices, as discussed in greater detail below.

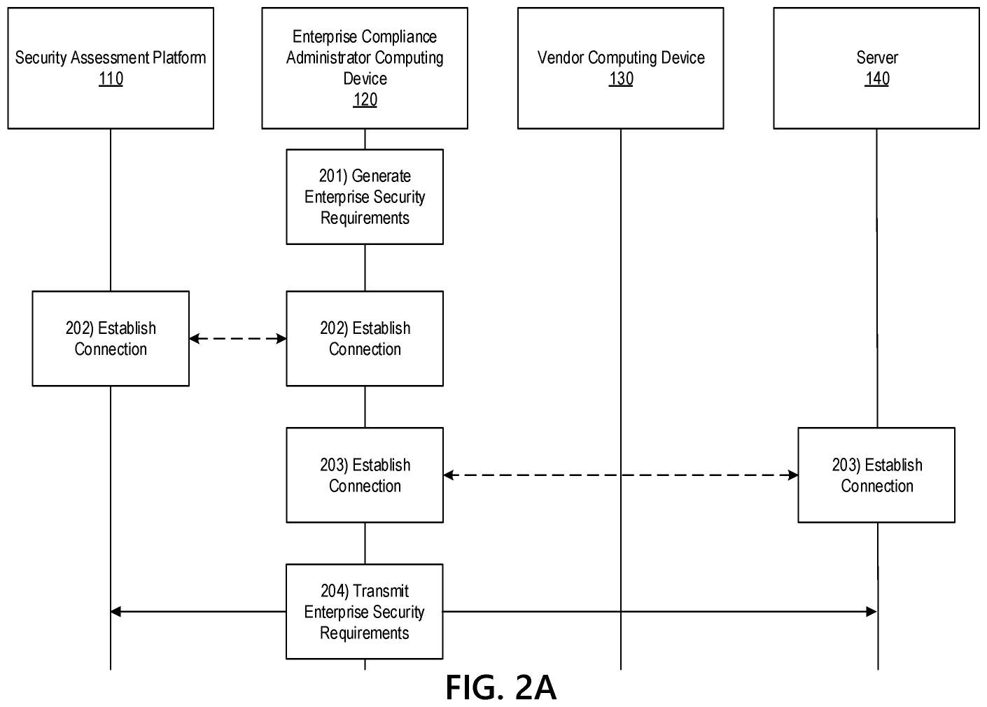

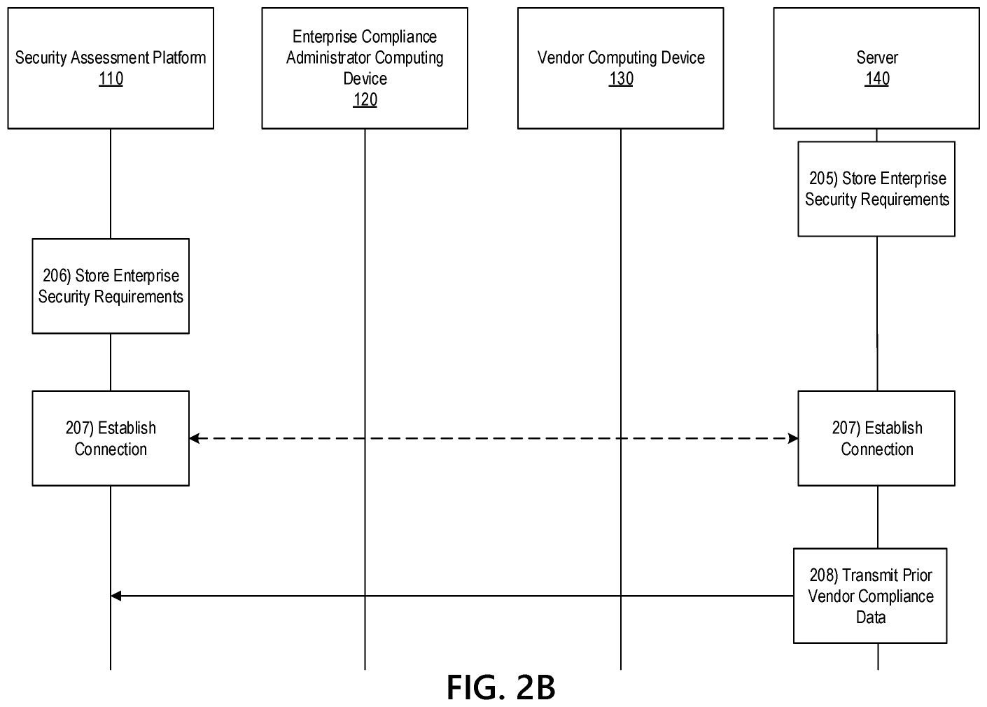

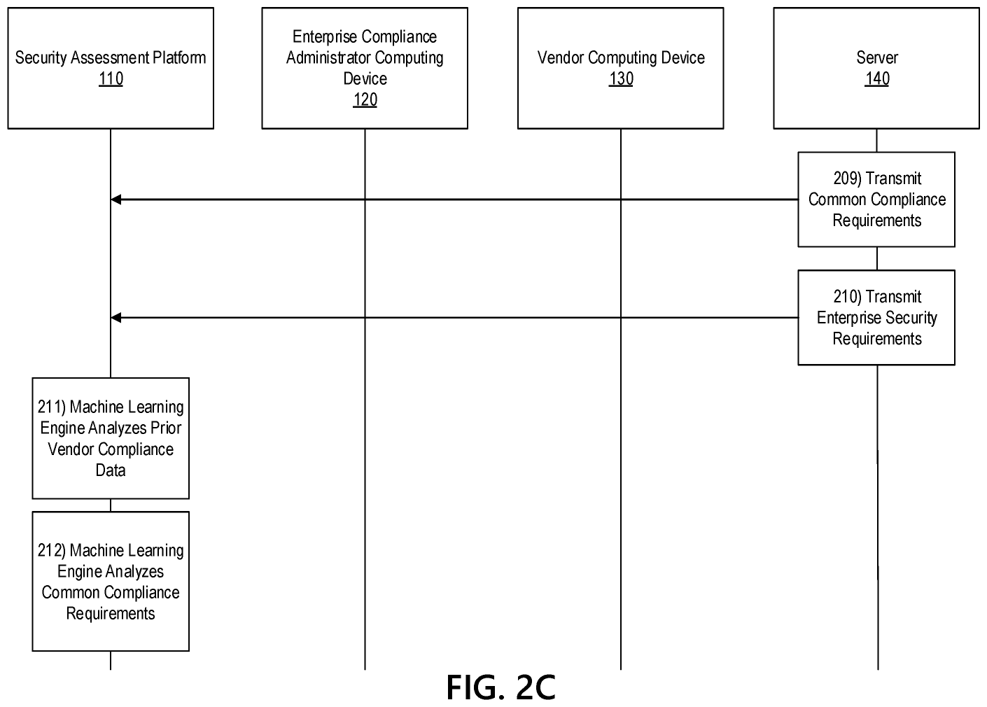

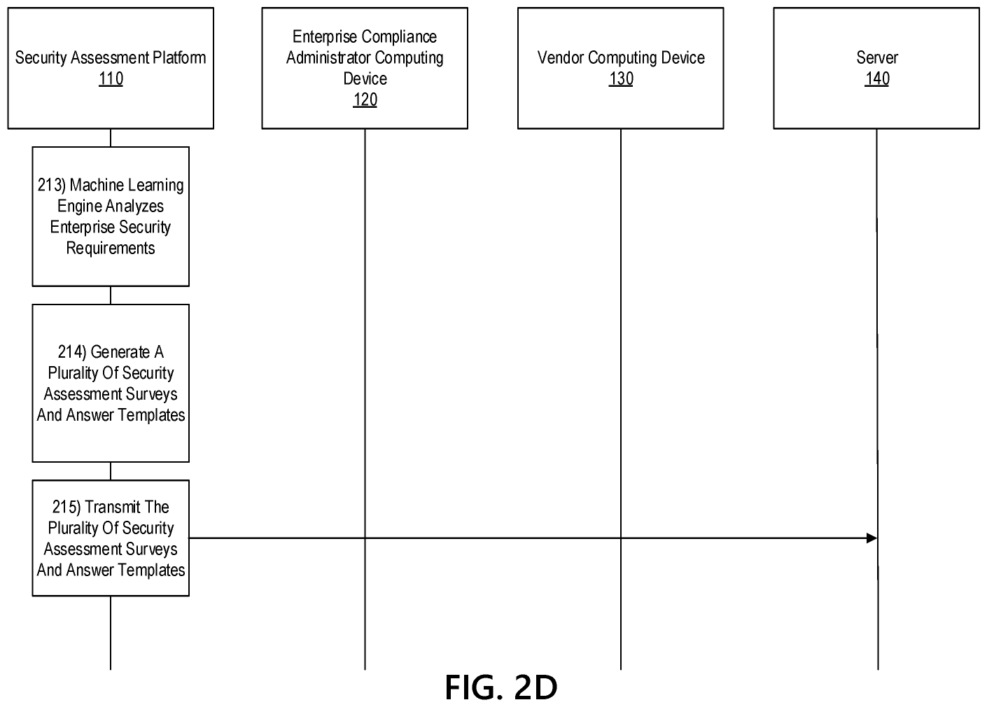

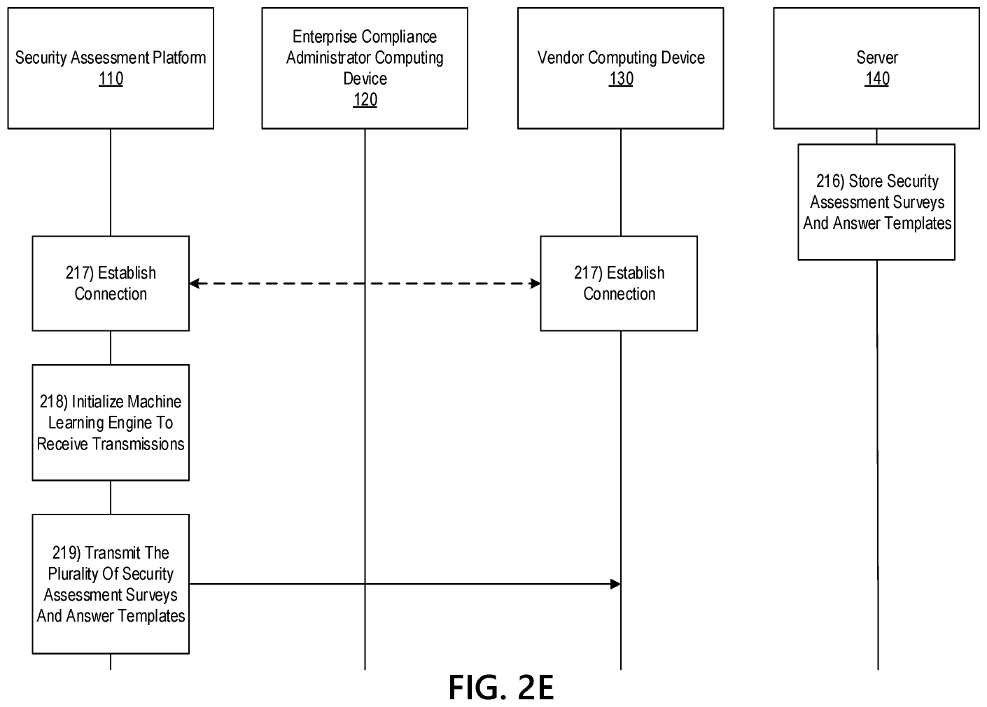

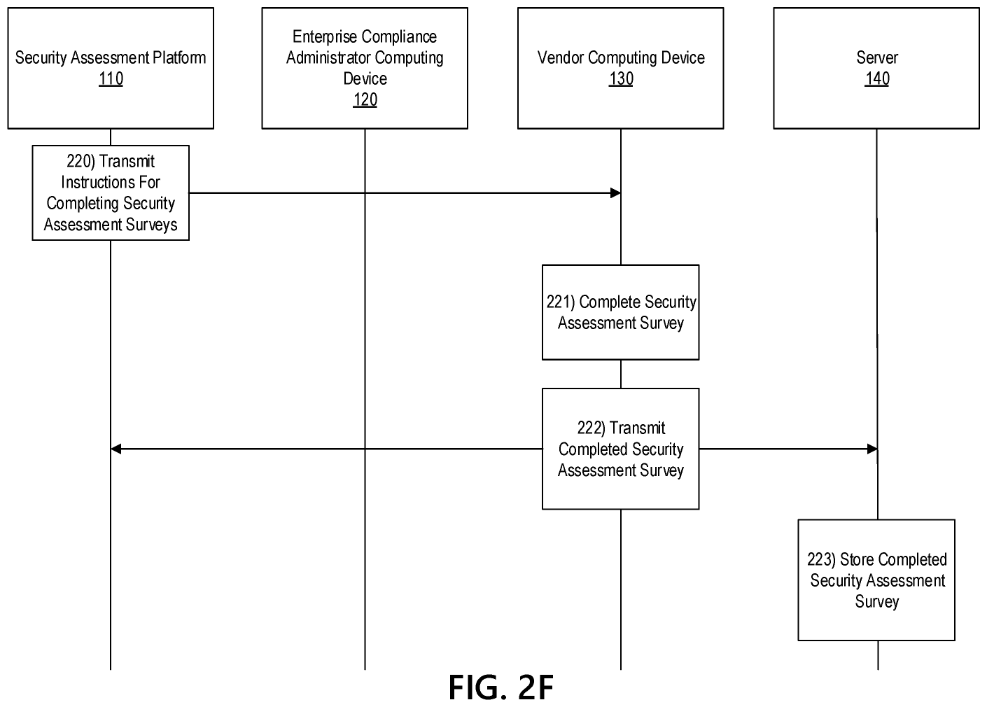

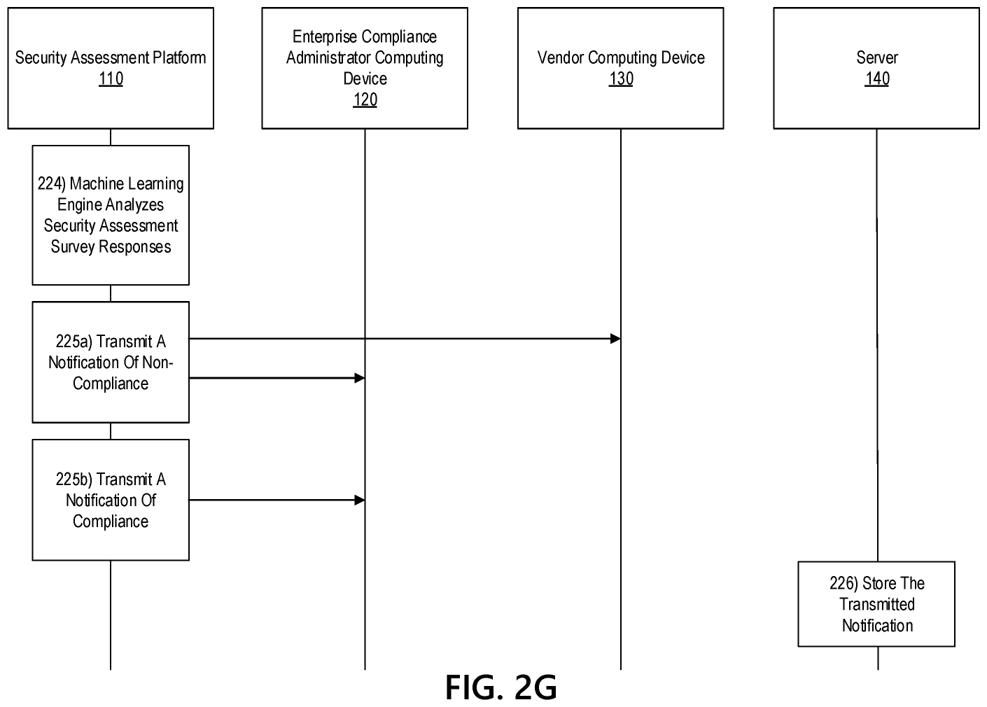

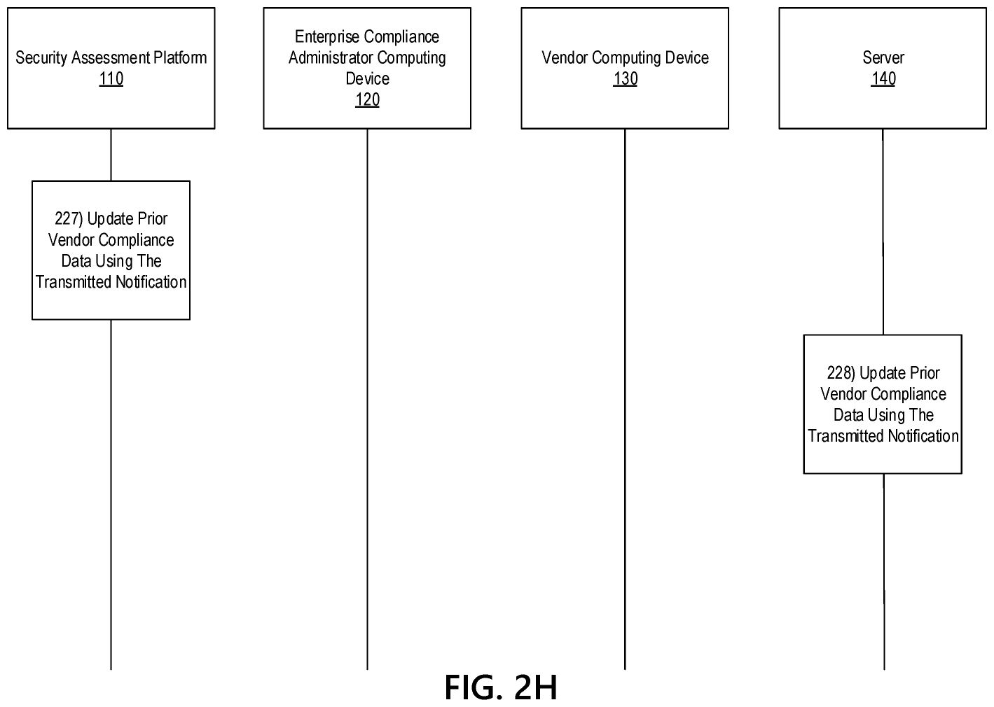

FIGS. 2A-2H depict an illustrative event sequence for training and using a machine learning engine to continuously sustain security assessment protocols on vendor computing devices in accordance with one or more example embodiments. Referring to FIG. 2A, at step 201, enterprise compliance administrator computing device 120 may generate enterprise security requirements. Enterprise security requirements may be enterprise-specific protocols for ensuring that the sensitive enterprise data is protected from unauthorized access by unauthorized personnel. To generate the enterprise security requirements, enterprise compliance administrator computing device 120 may consider best practices (e.g., established security practices) for protecting the sensitive enterprise data. Enterprise compliance administrator computing device 120 may consider the system requirements to execute the best practices for protecting the sensitive enterprise data. In particular, enterprise compliance administrator computing device 120 may consider the system requirements that vendor computing device 130 may need to satisfy to ensure that vendor computing device 130 safely interacts with the sensitive enterprise data.

For example, in some embodiments, enterprise compliance administrator computing device 120 may determine that a particular malware program is required to protect the sensitive enterprise data from unauthorized access. As such, one of the enterprise security requirements that may be generated by enterprise compliance administrator computing device 120 may require vendor computing device 130 to ensure the particular malware program is running on vendor computing device 130 and to ensure the particular malware program is updated as needed, on a predetermined schedule, within a predefined time of updates being available, or the like. Enterprise compliance administrator computing device 120 may explore additional system requirements for vendor computing device 130 and compile all system requirements to generate a list of enterprise security requirements.

At step 202, security assessment platform 110 may establish a network connection with enterprise compliance administrator computing device 120. The connection between security assessment platform 110 and enterprise compliance administrator computing device 120 may be established across network 150. As discussed in subsequent steps, security assessment platform 110 may transmit security assessment data to and from enterprise compliance administrator computing device 120. As such, the network connection between security assessment platform 110 and enterprise compliance administrator computing device 120 may facilitate the data transmission between security assessment platform 110 and enterprise compliance administrator computing device 120.

At step 203, enterprise compliance administrator computing device 120 may establish a connection with server 140. The connection between enterprise compliance administrator computing device 120 and server 140 may be established across network 150. Server 140 may store security assessment data that is transmitted to and from enterprise compliance administrator computing device 120. The security assessment data that is transmitted to and from enterprise compliance administrator computing device 120 may be used in future iterations of training a machine learning model to continuously sustain security assessment protocols on vendor computing devices, described herein. As such, server 140 may store the transmitted security data for future analyses.

At step 204, enterprise compliance administrator computing device 120 may transmit the generated enterprise security requirements to security assessment platform 110 and server 140. Security assessment platform 110 may use the transmitted enterprise security requirements to train a machine learning model to continuously sustain security assessment protocols on vendor computing device 130, as discussed herein. Server 140 may use the transmitted enterprise security requirements in future iterations of training and/or using a machine learning model to continuously sustain security assessment protocols on vendor computing devices, described herein.

Referring to FIG. 2B, at step 205, server 140 may store the enterprise security requirements transmitted from enterprise compliance administrator computing device 120 in step 204. At step 206, security assessment platform 110 may store the enterprise security requirements transmitted from enterprise compliance administrator computing device 120 in step 204.

At step 207, security assessment platform 110 may establish a connection with server 140. The connection between security assessment platform 110 and server 140 may be established across network 150. As discussed in subsequent steps, security assessment platform 110 may transmit security assessment data to and from server 140. As such, the network connection between security assessment platform 110 and server 140 may facilitate the data transmission between security assessment platform 110 and server 140.

At step 208, server 140 may transmit vendor compliance data from previous security assessments to security assessment platform 110. Security assessment platform 110 may store the transmitted vendor compliance data from previous security assessments within security assessment database 112b. Vendor compliance data from previous security assessments may include the enterprise security requirements that were used during previous security assessments. Vendor compliance data from previous security assessments may include the security assessment response data provided by vendor computing device 130 on the security assessment surveys that were used during previous security assessments. Vendor compliance data from previous security assessments may include an indication of whether vendor computing device 130 satisfied the security requirements that were used during previous security assessments. If vendor computing device 130 satisfied the security requirements, then the vendor compliance data from previous security assessments may state that the system settings of vendor computing device 130 complied with the system requirements that were dictated by the enterprise organization.

Additionally or alternatively, if vendor computing device 130 did not satisfy the security requirements that were used during previous security assessments, then the vendor compliance data from previous security assessments may indicate compliance requirements. The compliance requirements may provide a series of steps that vendor computing device 130 may execute in order to meet the system requirements set in place by the enterprise organization and to satisfy the security requirements.

For example, one of the security requirements used during previous security assessments may have required that vendor computing device 130 use multi-factor authentication to enable or permit access to enterprise data. The vendor compliance data from previous security assessments may indicate that vendor computing device 130 did not use multi-factor authentication prior to enabling or permitting access to enterprise data. As such, vendor compliance data from previous security assessments may indicate that vendor computing device 130 did not satisfy the enterprise security requirements. As a result, vendor compliance data from previous security assessments may provide a series of steps that vendor computing device 130 may follow in order to establish multi-factor authentication. If security assessments are performed after determining that vendor computing device 130 failed to use multi-factor authentication, then the vendor compliance data of the subsequent security assessments may indicate whether vendor computing device 130 instituted multi-factor authentication during subsequent security assessments. As such, the vendor compliance data from previous security assessments may provide a complete history of the behavior of vendor computing device 130.

Referring to FIG. 2C, at step 209, server 140 may transmit compliance requirements for commonly reported security gaps during security assessments to security assessment platform 110. Security assessment platform 110 may store the transmitted compliance requirements for commonly reported security gaps during security assessments within security assessment database 112b. In addition to using enterprise security requirements to perform security assessments on vendor computing device 130, security assessment platform 110 may also consult the security gaps that are commonly reported during security assessments. A security gap may indicate an instance where vendor behavior, across a plurality of vendors, might not have complied with industry security standards. Since the non-compliant behavior may have been common to a plurality of vendors, the non-compliant behavior may have been marked as a security gap that is commonly reported during security assessments. In response to indicating non-compliant behavior that may be common to a plurality of vendors, the particular industry may generate compliance requirements to remedy the non-compliant vendor behavior. Security assessment platform 110 may use the industry-generated compliance requirements to ensure that vendor computing device 130 not only satisfies the enterprise security requirements, but that vendor computing device 130 also satisfies industry-generated compliance requirements.

At step 210, server 140 may transmit enterprise security requirements to security assessment platform 110. Security assessment platform 110 may store the enterprise security requirements within security assessment database 112b. As discussed in connection with step 201, enterprise compliance administrator computing device 120 may generate enterprise security requirements. Enterprise security requirements may be enterprise-specific protocols for ensuring that sensitive enterprise data is protected from unauthorized access by unauthorized personnel. To generate the enterprise security requirements, enterprise compliance administrator computing device 120 may first consider best practices for protecting the sensitive enterprise data. Enterprise compliance administrator computing device 120 may consider the system requirements that may be necessary to execute the best practices for protecting the sensitive enterprise data. In particular, enterprise compliance administrator computing device 120 may consider the system requirements that vendor computing device 130 may need to satisfy to ensure that vendor computing device 130 safely interacts with the sensitive enterprise data.

At step 211, a machine learning model executed by machine learning engine 112a may analyze the vendor compliance data from previous security assessments. As discussed in step 208, vendor compliance data from previous security assessments may include the security requirements that were used during previous security assessments. Vendor compliance data from previous security assessments may include the security assessment response data provided by vendor computing device 130 on the security assessment surveys that were used during previous security assessments. Vendor compliance data from previous security assessments may include an indication of whether vendor computing device 130 satisfied the security requirements that were used during previous security assessments. If vendor computing device 130 satisfied the security requirements, then the vendor compliance data from previous security assessments may state that the system settings of vendor computing device 130 complied with the system requirements that were dictated by the enterprise organization. Alternatively, if vendor computing device 130 did not satisfy the security requirements that were used during previous security assessments, then the vendor compliance data from previous security assessments may indicate compliance requirements. The compliance requirements may provide guidelines that vendor computing device 130 may execute in order to meet the system requirements set in place by the enterprise organization and to satisfy the enterprise security requirements.

Machine learning engine 112a may analyze the vendor compliance data from previous security assessments to determine the security requirements that should be evaluated during the next security assessment. For example, if the vendor compliance data from previous security assessments indicates that vendor computing device 130 failed to satisfy a particular security requirement, security assessment platform 110 may flag that particular security requirement for evaluation during the next security assessment. Additionally or alternatively, if the vendor compliance data from previous security assessments indicates that vendor computing device 130 no longer needs to comply with a particular security requirement (e.g, based on machine learning analysis), then security assessment platform 110 may remove that particular security requirement from evaluation during the next security assessment. Machine learning engine 112a may repeat this analysis until machine learning engine 112a has reviewed all (or a predetermined amount) of the vendor compliance data from previous security assessments.

At step 212, machine learning engine 112a may analyze the compliance requirements for security gaps that are commonly reported during security assessments. As discussed in step 209, a security gap may indicate an instance where vendor behavior, across a plurality of vendors, might not have complied with industry security standards. Since the non-compliant behavior may have been common to a plurality of vendors, the non-compliant behavior may have been marked as a security gap that is commonly reported during security assessments. In response to indicating non-compliant behavior that may be common to a plurality of vendors, the particular industry may generate compliance requirements to remedy the non-compliant vendor behavior. Security assessment platform 110 may use the industry-generated compliance requirements to ensure that vendor computing device 130 not only satisfies the enterprise security requirements, but that vendor computing device 130 also satisfies industry-generated compliance requirements.

Machine learning engine 112a may analyze the compliance requirements for security gaps that are commonly reported during security assessments to determine the security requirements that should be evaluated during the next security assessment. For example, if the compliance requirements for security gaps that are commonly reported during security assessments indicate that vendor computing device 130 failed to satisfy a particular security requirement, security assessment platform 110 may flag that particular security requirement for evaluation during the next security assessment. Additionally or alternatively, if the compliance requirements for security gaps that are commonly reported during security assessments indicate that vendor computing device 130 no longer needs to comply with a particular security requirement, then security assessment platform 110 may remove that particular security requirement from evaluation during the next security assessment. Machine learning engine 112a may repeat this analysis until machine learning engine 112a has reviewed all (or a predetermined amount) of the compliance requirements for security gaps that are commonly reported during security assessments.

Referring to FIG. 2D, at step 213, machine learning engine 112a may analyze enterprise security requirements. As discussed in connection with steps 201 and 210, enterprise compliance administrator computing device 120 may generate enterprise security requirements. Enterprise security requirements may be enterprise-specific protocols for ensuring that the sensitive enterprise data is protected from unauthorized access by unauthorized personnel. Enterprise security requirements may indicate system requirements that vendor computing device 130 may need to satisfy to ensure that vendor computing device 130 safely interacts with the sensitive enterprise data.

Machine learning engine 112a may analyze the enterprise security requirements to determine the security requirements that should be evaluated during the next security assessment. For example, the enterprise security requirements may require vendor computing device 130 to have particular data loss prevention controls in place to ensure sensitive enterprise data cannot be removed from vendor computing device 130. Based on the machine learning analysis, security assessment platform 110 may flag this particular security requirement, and others, as security requirements that will be evaluated during the next security assessment. Additionally or alternatively, the enterprise security requirements may change with each security assessment. As such, machine learning engine 112a may analyze the enterprise security requirements to determine whether the enterprise security requirements list security requirements that no longer need to be evaluated. In such instances, security assessment platform 110 may flag the security requirements that no longer need to be evaluated and may remove those security requirements from subsequent security assessments until the enterprise security requirements indicate that otherwise.

At step 214, security assessment platform 110 may generate, based on analysis by machine learning engine 112a, a plurality of security assessment surveys and a plurality of answer templates, wherein each answer template corresponds to a security assessment survey of the plurality of security assessment surveys. Security assessment platform 110 may generate the plurality of security assessment surveys using the vendor compliance data from previous security assessments from steps 208 and 211, the compliance requirements for security gaps that are commonly reported during security assessments from steps 209 and 212, and the enterprise security requirements from steps 210 and 213.

In particular, security assessment platform 110 may look to the analysis of the vendor compliance data from previous security assessments, performed by machine learning engine 112a. Security assessment platform 110 may determine whether the vendor compliance data from previous security assessments indicates specific security requirements that vendor computing device 130 previously failed to satisfy. Security assessment platform 110 may pull the security requirements that vendor computing device 130 previously failed to satisfy and may incorporate them into the security requirements that will be evaluated in the next security assessment. Additionally or alternatively, security assessment platform 110 may determine whether the vendor compliance data from previous security assessments indicates security requirements that should be evaluated during each security assessment. Similarly, security assessment platform 110 may pull the security requirements that should be evaluated during each security assessment and may incorporate them into the security requirements that will be evaluated in the next security assessment.

Additionally or alternatively, security assessment platform 110 may look to the analysis of the compliance requirements for security gaps that are commonly reported during security assessments, performed by machine learning engine 112a. Security assessment platform 110 may determine whether there are industry-specific security requirements that should be evaluated during every security assessment. Security assessment platform 110 may gather the security requirements that should be evaluated during every security assessment and may incorporate them into the security requirements that will be evaluated in the next security assessment survey. Security assessment platform 110 may use the compliance requirements for security gaps that are commonly reported during security assessments to determine whether there are outdated industry-specific security requirements that no longer need to be evaluated. In such instances, security assessment platform 110 may remove the outdated industry-specific security requirements from the security requirements that should be evaluated during the next security assessment. Security assessment platform 110 may use the compliance requirements for security gaps that are commonly reported during security assessments to identity the security gaps that are common to vendors in the industry, and may incorporate the corresponding security requirements into the security requirements that should be evaluated during the next security assessment.

Additionally or alternatively, security assessment platform 110 may look to the analysis of the enterprise security requirements, performed by machine learning engine 112a, to determine the security requirements that should evaluated during the next security assessment. The enterprise security requirements may indicate the enterprise-specific security requirements that are necessary to protect sensitive enterprise data from unauthorized use and unauthorized access. As such, security assessment platform 110 may incorporate each security requirement listed on the enterprise security requirements into the security requirements that will be evaluated during the next security assessment.

As previously discussed, machine learning engine 112a may gather all of the security requirements from the vendor compliance data from previous security assessments, the compliance requirements for security gaps that are commonly reported during security assessments, and the enterprise security requirements. Security assessment platform 110 may compile all of the security requirements into a security assessment survey. The security assessment survey may contain a series of questions, each question corresponding to a particular security requirement from the vendor compliance data from previous security assessments, the compliance requirements for security gaps that are commonly reported during security assessments, or the enterprise security requirements.

The number of questions included within the security assessment survey may depend on the level of risk of the vendor. Vendors that regularly interact with sensitive enterprise data may be deemed a first level or high risk vendor because such vendors pose a greater security risk to the enterprise organization. Additionally or alternatively, vendors that do not regularly interact with sensitive enterprise data may be deemed a second level or low risk vendor because such vendors do not pose a great security risk to the enterprise organization. High risk or first level vendors may encounter a greater number of questions on the security assessment survey than low risk or second level vendors since high risk vendors pose a more significant security risk to the enterprise organization and must satisfy a greater number of security requirements than a low risk vendor.

The questions pertaining to the security requirements may appear as items in a list. The list of questions pertaining to the security requirements may appear in a column on the security assessment survey. The column next to the security requirements may provide a field wherein vendor computing device 130 may insert data responsive to each question pertaining to a specific security requirement.

Security assessment platform 110 may generate a plurality of answer templates, wherein each answer template corresponds to a security assessment survey of the plurality of security assessment surveys. Particular questions pertaining to particular security requirements may require a response with more information than other questions. For example, a question which asks whether vendor computing device 130 uses multi-factor authentication to enable or to permit access to sensitive enterprise data may require a YES or NO response. Additionally or alternatively, a question which asks vendor computing device 130 to explain the data loss prevention protocols currently in place may require a more detailed, text based response. As such, the answer template may indicate the level of detail required for each response such that security assessment platform 110 may thoroughly analyze each response, as discussed in step 224. Additionally or alternatively, the answer template may include a sample response such that vendor computing device 130 may consult the sample response to clear any confusion that may exist around a particular question and the required response.

At step 215, security assessment platform 110 may transmit the plurality of security assessment surveys and the plurality of answer templates to server 140. As discussed in step 228, server 140 may update vendor compliance data from previous security assessments after each security assessment is performed. To do so, server 140 may require the security requirements that were evaluated during previous security assessments as well the security assessment response data provided on the security assessment surveys that were evaluated during previous security assessments. Server 140 may gather the security requirements that were evaluated during previous security assessments, as well as the security assessment response data provided by vendor computing device 130, from the plurality of security assessment surveys that are transmitted to server 140 from security assessment platform 110.

Referring to FIG. 2E, at step 216, server 140 may store the plurality of security assessment surveys and the plurality of answer templates that were transmitted from security assessment platform 110.

At step 217, security assessment platform 110 may establish a connection with vendor computing device 130. The connection between security assessment platform 110 and vendor computing device 130 may be established across network 150. Security assessment platform 110 may transmit security assessment data to and from vendor computing device 130. As such, the network connection between security assessment platform 110 and vendor computing device 130 may facilitate the data transmission between security assessment platform 110 and vendor computing device 130.

At step 218, security assessment platform 110 may initialize machine learning engine 112a and security assessment evaluation module 112c to receive transmissions from vendor computing device 130. Initializing machine learning engine 112a and security assessment evaluation module 112c to receive transmissions from vendor computing device 130 may require revisiting the network connection between security assessment platform 110 and vendor computing device 130, established in step 217, to determine whether the connection was established properly. The connection was established properly if the network connection between security assessment platform 110 and vendor computing device 130 can transmit communication between security assessment platform 110 and vendor computing device 130. Additionally or alternatively, if the network connection between security assessment platform 110 and vendor computing device 130 cannot transmit communication between security assessment platform 110 and vendor computing device 130, then the network connection in step 217 may be re-established until the network connection can support communication between security assessment platform 110 and vendor computing device 130.

Initializing machine learning engine 112a and security assessment evaluation module 112c to receive transmissions from vendor computing device 130 may include loading vendor-specific communication requirements that security assessment platform 110 may need to satisfy prior to communicating with vendor computing device 130. Since vendor computing device 130 is affiliated with the enterprise organization and may have access to sensitive enterprise data, vendor computing device 130 may be required to follow particular protocols when communicating with devices outside of the enterprise organization. The communication protocol may ensure the safety of sensitive enterprise data and sensitive vendor data.

At step 219, security assessment platform 110 may transmit the plurality of security assessment surveys and the plurality of answer templates to vendor computing device 130. The transmission of the plurality of the security assessment surveys and the plurality of the answer templates to vendor computing device 130 may occur over the network connection established between security assessment platform 110 and vendor computing device 130 in step 217.

Referring to FIG. 2F, at step 220, security assessment platform 110 may transmit instructions for completing a security assessment survey to vendor computing device 130. The transmitted instructions may indicate that the plurality of the security assessment surveys that were transmitted to vendor computing device 130 contain a variety of security assessment surveys. The instructions may contain embedded instructions that may execute on vendor computing device 130 and lead vendor computing device 130 to the specific security assessment survey that vendor computing device 130 should complete. The embedded instructions may lead vendor computing device 130 to the answer template that corresponds to the security assessment survey intended for vendor computing device 130. The instructions may indicate that the answer templates provide sample responses that vendor computing device 130 may consult when completing the security assessment survey. The instructions may direct vendor computing device 130 to enter responses to the security assessment survey on the security assessment survey rather than entering responses to the security assessment survey on the accompanying answer template. The instructions may address the procedure that vendor computing device 130 may undertake to return the security assessment survey to security assessment platform 110. For example, the instructions may require vendor computing device 130 to transmit the completed security assessment survey across the network connection established between security assessment platform 110 and vendor computing device 130 in step 217.

At step 221, vendor computing device 130 may complete the security assessment survey that was specifically generated for vendor computing device 130. To complete the security assessment survey that was specifically generated for vendor computing device 130, the embedded instructions may execute on vendor computing device 130 and may lead vendor computing device 130 to the security assessment survey that was generated for vendor computing device 130. The embedded instructions may execute on vendor computing device 130 and may lead vendor computing device 130 to the answer template that corresponds to the security assessment survey that was specifically generated for vendor computing device 130.

Vendor computing device 130 may review the questions within the security assessment survey and provide response data in the fields provided on the security assessment survey. Vendor computing device 130 may then execute the steps listed in the instructions for returning the completed security assessment survey, containing the security assessment response data, to security assessment platform 110. For example, the instructions may require vendor computing device 130 to transmit the completed security assessment survey to security assessment platform 110 and server 140. The instructions may indicate vendor computing device 130 transmit the completed security assessment survey to security assessment platform 110 such that machine learning engine 112a and security assessment evaluation module 112c may analyze the security assessment response data provided on the completed security assessment survey. The instructions may indicate vendor computing device 130 transmit the completed security assessment survey to server 140 such that server 140 may use the completed security assessment survey to update the vendor compliance data from previous security assessments, which may be stored on server 140, as discussed in connection with step 228.

At step 222, vendor computing device 130 may transmit the completed security assessment survey to security assessment platform 110 and server 140. As discussed in connection with step 220, the instructions may require vendor computing device 130 to transmit the completed security assessment survey to security assessment platform 110 such that machine learning engine 112a and security assessment evaluation module 112c may analyze the response data provided in the completed security assessment survey. As discussed in connection with step 220 and step 228, the instructions may include an instruction for vendor computing device 130 to transmit the completed security assessment survey to server 140 such that server 140 may use the completed security assessment survey to update the vendor compliance data from previous security assessments, which may be stored on server 140.

At step 223, server 140 may store the completed security assessment survey. Server 140 may use the completed security assessment survey to update the vendor compliance data from previous security assessments, as discussed in step 220 and step 228.

Referring to FIG. 2G, at step 224, machine learning engine 112a may analyze the security assessment response data provided by vendor computing device 130 on the completed security assessment survey. To analyze the security assessment response data provided by vendor computing device 130 on the completed security assessment survey, security assessment evaluation module 112c may load, from security assessment database 112b, the vendor compliance data from previous security assessments, the compliance requirements for security gaps that are commonly reported during security assessments, and the enterprise security requirements. Machine learning engine 112a may compare the security assessment response data provided on the completed security assessment survey with the security requirements listed in the vendor compliance data from previous security assessments, the compliance requirements for security gaps that are commonly reported during security assessments, and the enterprise security requirements. If the security assessment response data provided on the completed security assessment survey complies with the security requirement, security assessment platform 110 may mark that particular response as “Compliant.” Additionally or alternatively, if the security assessment response data provided on the completed security assessment survey fails to comply with the security requirement, security assessment platform 110 may mark that particular response as “Non-Compliant.” Machine learning engine 112a may continue the review and analysis process until each response on the completed security assessment survey has been checked against the vendor compliance data from previous security assessments, the compliance requirements for security gaps that are commonly reported during security assessments, and the enterprise security requirements.

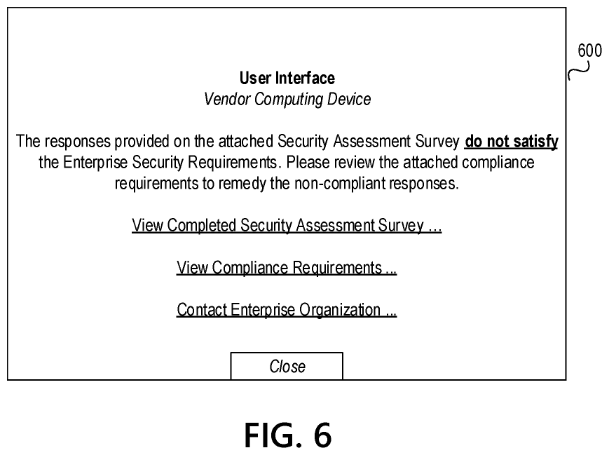

At step 225a, security assessment platform 110 may transmit a notification of non-compliance to vendor computing device 130 and enterprise compliance administrator computing device 120, as illustrated in FIGS. 5 and 6. After determining that the response data provided by vendor computing device 130 on the completed security assessment survey does not comply with the security requirements used during the security assessment, security assessment platform 110 may generate a notification indicating that vendor computing device 130 does not comply with the security requirements listed in the vendor compliance data from previous security assessments, the compliance requirements for security gaps that are commonly reported during security assessments, or the enterprise security requirements.

In response to determining that vendor computing device 130 does not comply with the security requirements used during the security assessment, security assessment platform 110 may generate guidelines that vendor computing device 130 may execute to ensure vendor computing device 130 complies with the security requirements used during the security assessment. Security assessment platform 110 may transmit the guidelines along with the notification of non-compliance to vendor computing device 130. Security assessment platform 110 may transmit the notification of non-compliance to enterprise compliance administrator computing device 120 to inform enterprise compliance administrator computing device 120 that vendor computing device 130 does not satisfy the security requirements for interacting with sensitive enterprise data. Security assessment platform 110 may inform enterprise compliance administrator computing device 120 that guidelines were provided to vendor computing device 130 to comply with the security requirements used during the security assessment.

In response to transmitting a notification of non-compliance, machine learning engine 112a may determine a timeframe for performing the next security assessment on vendor computing device 130. The timeframe for performing the next security assessment on vendor computing device 130 may depend on the risk level of vendor computing device 130. For example, if vendor computing device 130 is a first level or high risk vendor, then machine learning engine 112a may perform security assessments on vendor computing device 130 more frequently than if vendor computing device 130 were a second level or low risk vendor. Moreover, if machine learning device 112a determines that vendor computing device 130 failed to satisfy a great number of security requirements, then machine learning engine 112a may perform security assessments on vendor computing device 130 more frequently to monitor whether vendor computing device 130 satisfies the security requirements used during security assessments.

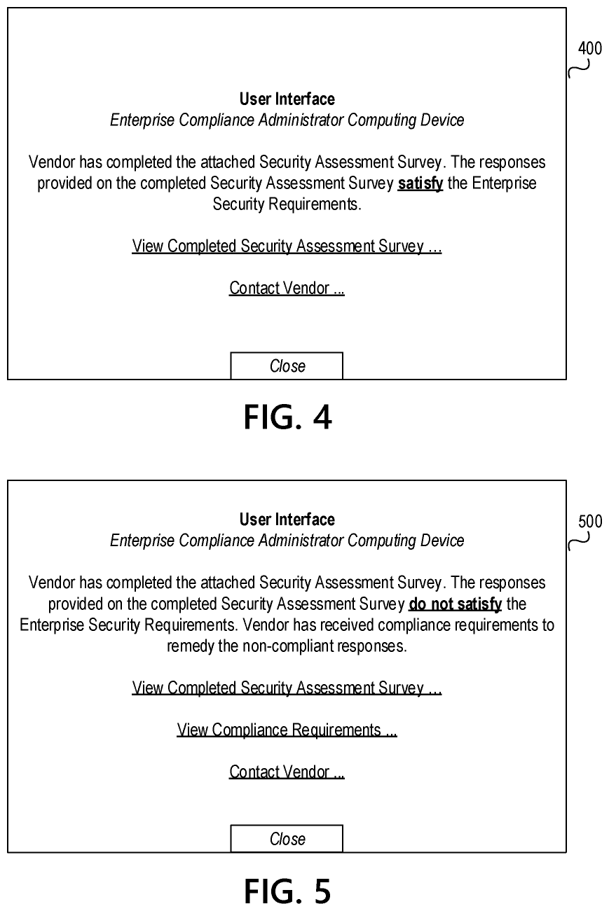

Additionally or alternatively, at step 225b, security assessment platform 110 may transmit a notification of compliance to enterprise compliance administrator computing device 120, as illustrated in FIG. 4. FIG. 4 includes one example user interface 400 including an example notification of compliance that may be transmitted to the enterprise compliance administrator computing device 120.

After determining that the security assessment response data provided by vendor computing device 130 on the completed security assessment survey complies with the security requirements used during the security assessment, security assessment platform 110 may generate a notification indicating that vendor computing device 130 complies with the security requirements listed in the vendor compliance data from previous security assessments, the compliance requirements for security gaps that are commonly reported during security assessments, and the enterprise security requirements. Security assessment platform 110 may transmit the notification of compliance to enterprise compliance administrator computing device 120 to inform enterprise compliance administrator computing device 120 that vendor computing device 130 satisfies the security requirements for interacting with sensitive enterprise data.

In response to transmitting a notification of compliance, machine learning engine 112a may determine a timeframe for performing the next security assessment on vendor computing device 130. The timeframe for performing the next security assessment on vendor computing device 130 may depend on the risk level of vendor computing device 130. For example, if vendor computing device 130 is a second level or low risk vendor, then machine learning engine 112a may perform security assessments on vendor computing device 130 less frequently than if vendor computing device 130 were a first level or high risk vendor. Moreover, if machine learning device 112a determines that vendor computing device 130 satisfied all of the security requirements, then machine learning engine 112a may perform security assessments on vendor computing device 130 less frequently.

At step 226, server 140 may store the notification that was transmitted in either step 225a or step 225b. Server 140 may add the transmitted notification to the vendor compliance data from previous security assessments, as discussed in step 228.

Referring to FIG. 2H, at step 227, security assessment platform 110 may update or validate vendor compliance data from previous security assessments, stored in security assessment database 112b, using the notification transmitted either step 225a or step 225b. Security assessment platform 110 may add the security requirements used during the present security assessment to the vendor compliance data from previous security assessments. Security assessment platform 110 may add the security assessment response data provided by vendor computing device 130 on the completed security assessment survey to the vendor compliance data from previous security assessments. The updated vendor compliance data from previous security assessments may be used in future iterations of training and using a machine learning model (e.g., the data may be used to validate the model to continuously improve accuracy) to continuously sustain security assessment protocols on vendor computing devices, as described herein. For example, the updated vendor compliance data from previous security assessments may be used in future iterations to determine the security requirements that should be evaluated in subsequent security assessments.

At step 228, server 140 may update vendor compliance data from previous security assessments using the notification transmitted in either step 225a or step 225b. Server 140 may add the security requirements used during the present security assessment to the vendor compliance data from previous security assessments. Server 140 may add the security assessment response data provided by vendor computing device 130 on the completed security assessment survey to the vendor compliance data from previous security assessments. The updated vendor compliance data from previous security assessments may be used in future iterations of training and using a machine learning model to continuously sustain security assessment protocols on vendor computing devices, as described herein. For example, the updated vendor compliance data from previous security assessments may be used in future iterations to determine the security requirements that should be evaluated in subsequent security assessments.

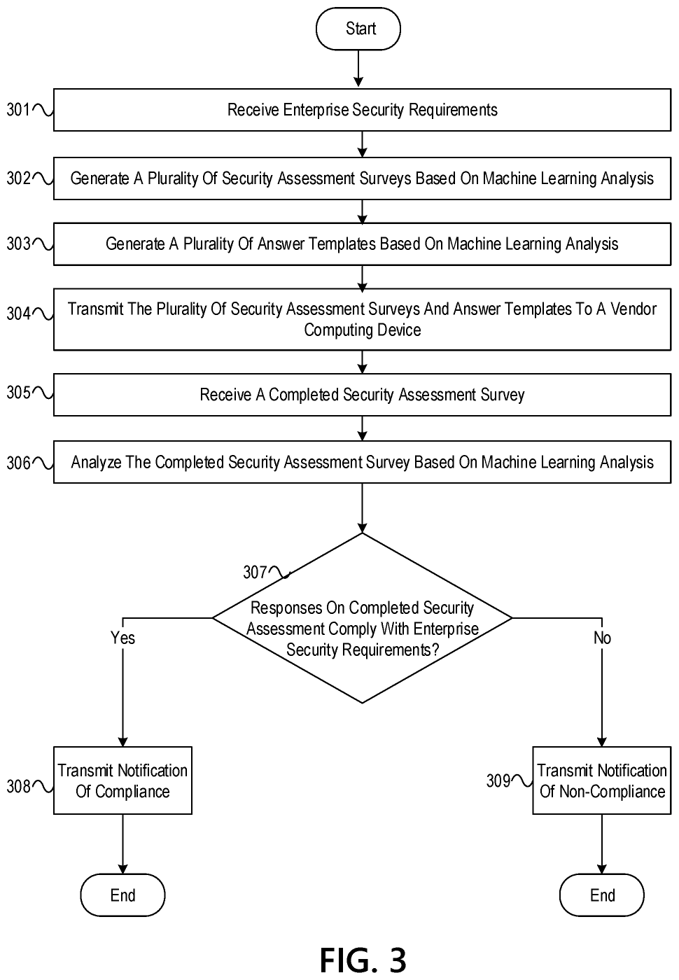

FIG. 3 is a flow chart illustrating one example method of training a machine learning engine to continuously sustain security assessment protocols on vendor computing devices according to one or more aspects described herein. The processes illustrated in FIG. 3 are merely sample processes and functions. The steps shows may be performed in the order shown, in a different order, more steps may be added, or one or more steps may be omitted, without departing from the invention. In some examples, one or more steps may be performed simultaneously with other steps shown and described.

At step 301, security assessment platform 110 may receive enterprise security requirements generated by enterprise compliance administrator computing device 120. Enterprise security requirements may be enterprise-specific protocols for ensuring that sensitive enterprise data is protected from unauthorized access by unauthorized personnel. To generate the enterprise security requirements, enterprise compliance administrator computing device 120 may consider best practices (e.g., established security practices) for protecting the sensitive enterprise data. Enterprise compliance administrator computing device 120 may consider the system requirements to execute the best practices for protecting the sensitive enterprise data. In particular, enterprise compliance administrator computing device 120 may consider the system requirements that vendor computing device 130 may need to satisfy to ensure that vendor computing device 130 safely interacts with the sensitive enterprise data.

At step 302, security assessment platform 110 may generate a plurality of security assessment surveys based on analysis performed by machine learning engine 112a. Machine learning engine 112a may analyze vendor compliance data from previous security assessments, compliance requirements for security gaps that are commonly reported during security assessments, and enterprise security requirements. Security assessment platform 110, based on the analysis performed by machine learning engine 112a, may flag the security requirements that should be evaluated during subsequent security assessments. Security assessment platform 110 may compile all of the security requirements that should be evaluated during subsequent security assessments into a plurality of security assessment surveys.

At step 303, security assessment platform 110 may generate a plurality of answer templates, based on machine analysis performed by machine learning engine 112a, where each answer template may correspond to a security assessment survey of the plurality of security assessment surveys. Particular questions pertaining to particular security requirements may require a response with more information than other questions. For example, a question which asks whether vendor computing device 130 uses multi-factor authentication to enable or to permit access to sensitive enterprise data may require a YES or NO response. Additionally or alternatively, a question which asks vendor computing device 130 to explain the data loss prevention protocols currently in place may require a more detailed, text based response. As such, the answer template may indicate the level of detail required for each response. Additionally or alternatively, the answer template may include a sample response such that vendor computing device 130 may consult the sample response to clear any confusion that may exist around a particular question and the required response.

At step 304, security assessment platform 110 may transmit the plurality of security assessment surveys and the plurality of answer templates to vendor computing device 130. The transmission of the plurality of security assessment surveys and the plurality of answer templates to vendor computing device 130 may occur over a network connection established between security assessment platform 110 and vendor computing device 130. Security assessment platform 110 may transmit, to vendor computing device 130, instructions, to be executed on vendor computing device 130, for completing the security assessment survey. The instructions may contain embedded instructions that may execute on vendor computing device 130 and lead vendor computing device 130 to the specific security assessment survey that vendor computing device 130 should complete. The embedded instructions may lead vendor computing device 130 to the answer template that corresponds to the security assessment survey intended for vendor computing device 130. The instructions may indicate that the answer templates provide sample responses that vendor computing device 130 may consult when completing the security assessment survey. The instructions may direct vendor computing device 130 to enter responses to the security assessment survey on the security assessment survey rather than entering responses to the security assessment survey on the accompanying answer template. The instructions may address the procedure that vendor computing device 130 may undertake to return the security assessment survey to security assessment platform 110. For example, the instructions may require vendor computing device 130 to transmit the completed security assessment survey across the network connection established between security assessment platform 110 and vendor computing device 130.

At step 305, security assessment platform 110 may receive a completed security assessment survey, from vendor computing device 130, including security assessment response data to the questions listed on the security assessment platform. Security assessment platform 110 may receive the completed security assessment survey from vendor computing device 130 across the network connection established between security assessment platform 110 and vendor computing device 130.

At step 306, security assessment platform 110 may analyze, based on machine analysis performed by machine learning engine 112a, the security response data provided on the completed security assessment survey. Machine learning engine 112a may compare the security assessment response data provided on the completed security assessment survey with the security requirements listed in the vendor compliance data from previous security assessments, the compliance requirements for security gaps that are commonly reported during security assessments, and the enterprise security requirements. If the response data provided on the completed security assessment survey complies with the security requirement, security assessment platform 110 may mark that particular response as “Compliant.” Additionally or alternatively, if the response provided on the completed security assessment survey fails to comply with the security requirement, security assessment platform 110 may mark that particular response as “Non-Compliant.”

At step 307, security assessment platform 110 may determine whether the security assessment response data provided on the completed security assessment survey, provided by vendor computing device 130, satisfies the enterprise security requirements. If the response data provided on the completed security assessment survey complies with the security requirement, security assessment platform 110 may mark that particular response as “Compliant.” Additionally or alternatively, if the response provided on the completed security assessment survey fails to comply with the security requirement, security assessment platform 110 may mark that particular response as “Non-Compliant.”

At step 308, in response to determining that the security assessment response data satisfies the enterprise security requirements, security assessment platform 110 may transmit a notification of compliance to enterprise compliance administrator computing device 120. The notification of compliance may indicate that vendor computing device 130 satisfies the enterprise security requirements for interacting with sensitive enterprise data.

Alternatively, at step 309, in response to determining that the security assessment response data fails to comply with the security requirements, security assessment platform 110 may transmit a notification of non-compliance to enterprise compliance administrator computing device 120 and vendor computing device 130. The notification of non-compliance may indicate that vendor computing device 130 fails to satisfy the enterprise security requirements for interacting with sensitive enterprise data. The notification may include guidelines to be executed by vendor computing device 130 to assist vendor computing device 130 with satisfying the security requirements evaluated on the security assessment survey.

FIG. 5 illustrates one example user interface 500 including an example notification of non-compliance that may be transmitted to enterprise compliance administrator computing device 120. The notification of non-compliance may indicate that vendor computing device 130 failed to satisfy the enterprise security requirements that were evaluated on the security assessment survey. The notification of non-compliance may allow enterprise compliance administrator computing device 120 to review the completed security assessment survey submitted by vendor computing device 130. The notification of non-compliance may allow enterprise compliance administrator computing device 120 to review the compliance requirements that vendor computing device 130 may execute to satisfy the security requirements evaluated on the security assessment survey. The notification of non-compliance may allow enterprise compliance administrator computing device 120 to contact vendor computing device 130.

FIG. 6 illustrates one example user interface 600 including an example notification of non-compliance that may be transmitted to vendor computing device 130. The notification of non-compliance may indicate that vendor computing device 130 failed to satisfy the enterprise security requirements that were evaluated on the security assessment survey. The notification of non-compliance may allow vendor computing device 130 to review the completed security assessment survey. The notification of non-compliance may allow vendor computing device 130 to review compliance requirements that, when executed by vendor computing device 130, may satisfy the security requirements evaluated on the security assessment survey. The notification of non-compliance may allow vendor computing device 130 to contact enterprise compliance administrator computing device 120.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an enterprise computing platform, or as one or more non-transitory computer-readable media storing instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space).

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive, via a connection established with an enterprise compliance administrator computing device, enterprise security requirements transmitted from the enterprise compliance administrator computing device;
generate, based on machine learning analysis, a plurality of security assessment surveys;
generate, based on the machine learning analysis, a plurality of answer templates corresponding to each security assessment survey of the plurality of the security assessment surveys, and including instructions, to be executed by a vendor computing device, for completing the security assessment survey;
transmit, via a connection established with the vendor computing device, the plurality of the security assessment surveys and the plurality of the answer templates to the vendor computing device;
receive, from the vendor computing device, a completed security assessment survey including security assessment response data;
analyze, based on the machine learning analysis, the completed security assessment survey including the security assessment response data;
generate a notification, the notification including one of:
compliance with the enterprise security requirements based on determining that the security assessment response data provided on the completed security assessment survey satisfies the enterprise security requirements; or
noncompliance with the enterprise security requirements based on determining that the security assessment response data provided on the
completed security assessment survey does not satisfy the enterprise
security requirements; and
transmit, to the enterprise compliance administrator computing device, the generated notification.

2. The computing platform of claim 1, wherein the generating the plurality of the security assessment surveys comprises:
analyzing, by a machine learning engine, vendor compliance data from previous security assessments;
analyzing, by the machine learning engine, compliance requirements for security gaps that are commonly reported during a security assessment;
analyzing, by the machine learning engine, the enterprise security requirements; and
generating questions to determine whether:
the vendor computing device satisfies compliance requirements within the vendor compliance data from the previous security assessments;
the vendor computing device satisfies the compliance requirements for the security gaps that are commonly reported during the security assessment; and
the vendor computing device satisfies the enterprise security requirements.

3. The computing platform of claim 2, wherein the vendor compliance data from the previous security assessments comprises:
security assessment response data to previous security assessment surveys, provided by the vendor, on the completed security assessment survey;
an indication that:
the security assessment response data, provided by the vendor, on the previous security assessment surveys complies with the enterprise security requirements; or
the security assessment response data, provided by the vendor, on the previous security assessment surveys does not comply with the enterprise security requirements; and
compliance requirements to remedy the security assessment response data, provided by the vendor, on the previous security assessment surveys that do not comply with the enterprise security requirements.

4. The computing platform of claim 2, wherein the compliance requirements for the security gaps that are commonly reported during the security assessment comprise:
a list of the security gaps that are commonly reported during the security assessment; and
compliance requirements to remedy the list of the security gaps that are commonly reported during the security assessment.

5. The computing platform of claim 1, wherein the transmitting the plurality of the security assessment surveys and the plurality of the answer templates to the vendor computing device comprises transmitting, to the vendor computing device, instructions to complete the security assessment survey using the answer template that corresponds to the security assessment survey.

6. The computing platform of claim 1, wherein a number of security questions within the security assessment survey is based on a security risk level of a vendor, wherein the security assessment survey transmitted to a second level or low risk vendor contains fewer security questions than the security assessment survey transmitted to a first level or high risk vendor.

7. The computing platform of claim 1, wherein the transmitting the generated notification further comprises:
transmitting the noncompliance notification to the vendor computing device.

8. The computing platform of claim 1, wherein the instructions, when executed, cause the computing platform to update, using the transmitted notification, vendor compliance data from previous security assessments.

9. A method comprising:
at a computing platform comprising at least one processor, memory, and a communication interface:
receiving, via a connection established with an enterprise compliance administrator computing device, enterprise security requirements transmitted from the enterprise compliance administrator computing device;
generating, based on machine learning analysis, a plurality of security assessment surveys;
generating, based on the machine learning analysis, a plurality of answer templates corresponding to each security assessment survey of the plurality of the security assessment surveys, and including instructions, to be executed by a vendor computing device, for completing the security assessment survey;
transmitting, via a connection established with the vendor computing device, the plurality of the security assessment surveys and the plurality of the answer templates to the vendor computing device;
receiving, from the vendor computing device, a completed security assessment survey including security assessment response data;
analyzing, based on the machine learning analysis, the completed security assessment survey including the security assessment response data;
generating a notification, the notification including one of:
compliance with the enterprise security requirements based on determining that the security assessment response data provided on the completed security assessment survey satisfies the enterprise security requirements; or
noncompliance with the enterprise security requirements based on determining that the security assessment response data provided on the completed security assessment survey does not satisfy the enterprise security requirements; and
transmitting, to the enterprise compliance administrator computing device, the generated notification.

10. The method of claim 9, wherein the generating the plurality of the security assessment surveys comprises:
analyzing, by a machine learning engine, vendor compliance data from previous security assessments;
analyzing, by the machine learning engine, compliance requirements for security gaps that are commonly reported during a security assessment;
analyzing, by the machine learning engine, the enterprise security requirements; and
generating questions to determine whether:
the vendor computing device satisfies compliance requirements within the vendor compliance data from the previous security assessments;
the vendor computing device satisfies the compliance requirements for the security gaps that are commonly reported during the security assessment; and
the vendor computing device satisfied the enterprise security requirements.

11. The method of claim 10, wherein the vendor compliance data from the previous security assessments comprises:
security assessment response data to previous security assessment surveys, provided by the vendor, on the completed security assessment survey;
an indication that:
the security assessment response data, provided by the vendor, on the previous security assessment surveys complies with the enterprise security requirements; or
the security assessment response data, provided by the vendor, on the previous security assessment surveys does not comply with the enterprise security requirements; and
compliance requirements to remedy the security assessment response data, provided by the vendor, on the previous security assessment surveys that do not comply with the enterprise security requirements.

12. The method of claim 10, wherein the compliance requirements for the security gaps that are commonly reported during the security assessment comprise:
a list of the security gaps that are commonly reported during the security assessment; and
compliance requirements to remedy the list of the security gaps that are commonly reported during the security assessment.

13. The method of claim 9, wherein the transmitting the generated notification further comprises:
transmitting the noncompliance notification to the vendor computing device.

14. The method of claim 9, further comprising updating, using the transmitted notification, vendor compliance data from previous security assessments.

15. One or more non-transitory computer-readable media storing instructions that, when executed by a computing platform comprising at least one processor, memory, and a communication interface, cause the computing platform to:
receive, via a connection established with an enterprise compliance administrator computing device, enterprise security requirements transmitted from the enterprise compliance administrator computing device;
generate, based on machine learning analysis, a plurality of security assessment surveys;
generate, based on the machine learning analysis, a plurality of answer templates corresponding to each security assessment survey of the plurality of the security assessment surveys, and including instructions, to be executed by a vendor computing device, for completing the security assessment survey;
transmit, via a connection established with the vendor computing device, the plurality of the security assessment surveys and the plurality of the answer templates to the vendor computing device;
receive, from the vendor computing device, a completed security assessment survey including security assessment response data;
analyze, based on the machine learning analysis, the completed security assessment survey including the security assessment response data;
generate a notification, the notification including one of:
compliance with the enterprise security requirements based on determining that the security assessment response data provided on the completed security assessment survey satisfies the enterprise security requirements; or
noncompliance with the enterprise security requirements based on determining that the security assessment response data provided on the completed security assessment survey does not satisfy the enterprise security requirements; and
transmit, to the enterprise compliance administrator computing device, the generated notification.

16. The one or more non-transitory computer-readable media of claim 15, wherein the generating the plurality of the security assessment surveys comprises:
analyzing, by a machine learning engine, vendor compliance data from previous security assessments;
analyzing, by the machine learning engine, compliance requirements for security gaps that are commonly reported during a security assessment;
analyzing, by the machine learning engine, the enterprise security requirements; and
generating questions to determine whether:
the vendor computing device satisfies compliance requirements within the vendor compliance data from the previous security assessments;
the vendor computing device satisfies the compliance requirements for the security gaps that are commonly reported during the security assessment; and
the vendor computing device satisfied the enterprise security requirements.

17. The one or more non-transitory computer-readable media of claim 16, wherein the vendor compliance data from the previous security assessments comprises:
security assessment response data to previous security assessment surveys, provided by the vendor, on the completed security assessment survey;
an indication that:
the security assessment response data, provided by the vendor, on the previous security assessment surveys complies with the enterprise security requirements; or
the security assessment response data, provided by the vendor, on the previous security assessment surveys does not comply with the enterprise security requirements; and
compliance requirements to remedy the security assessment response data, provided by the vendor, on the previous security assessment surveys that do not comply with the enterprise security requirements.

18. The one or more non-transitory computer-readable media of claim 16, wherein the compliance requirements for the security gaps that are commonly reported during the security assessment comprise:
a list of the security gaps that are commonly reported during the security assessment; and
compliance requirements to remedy the list of the security gaps that are commonly reported during the security assessment.

19. The one or more non-transitory computer-readable media of claim 15, wherein the transmitting the plurality of the security assessment surveys and the plurality of the answer templates to the vendor computing device comprises transmitting, to the vendor computing device, instructions to complete the security assessment survey using the answer template that corresponds to the security assessment survey.

20. The one or more non-transitory computer-readable media of claim 15, wherein a number of security questions within the security assessment survey is based on a security risk level of a vendor, wherein the security assessment survey transmitted to a second level or low risk vendor contains less security questions than the security assessment survey transmitted to a first level or high risk vendor.
